(19) United States
(12) Patent Application Publication
(10) Pub. No.: US 2011/0050643 A1
(43) Pub. Date: Mar. 3, 2011

(54) PASSIVE INFRARED SENSING USER INTERFACE AND DEVICE USING THE SAME

(75) Inventors: Rui Zhao, Shanghai (CN); Xudong Chen, Shanghai (CN); Shih-Kuang Tsai, Shanghai (CN)

(73) Assignee: INVENTEC APPLIANCES (Shanghai) CO., LTD./ INVENTEC APPLIANCES CORP.

(21) Appl. No.: 12/794,170

(22) Filed: Jun. 4, 2010

(30) Foreign Application Priority Data
Aug. 28, 2009 (CN) 200910194777.5

(51) Int. Cl. G06F 3/042

(52) U.S. Cl. 345/175

(57) ABSTRACT

A device (10) includes a passive infrared sensor (20) for user interface. When a user places his finger over the infrared sensor (20), the sensor (20) generate a digital signal indicating the time, position, or movement of the user finger over the sensor (20). A digital signal processing unit (12) processes the digital signal through preinstalled algorithms and generates a command to execute the user instruction through infrared interface. In operation, the user finger does not need to touch or press the infrared sensor (20). In addition, the passive infrared sensor (20) may be packaged under a cover to protect the sensor (20) from hazardous elements in the environment.

### FIELD OF THE INVENTION

The present invention generally relates to electronic device user interface and, more particularly, to user interface with a passive infrared sensor.

### BACKGROUND OF THE INVENTION

User interface is one of most important features in electronic devices, such as laptop computers, mobile telephones, digital cameras, personal digital assistants, digital audio video players, electronic books. Most user interfaces available on the market fall into two categories, keypad user interface and touchpad user interface.

A keypad user interface generally includes several keys on an electronic device. A user press one or more keys to interact with the electronic device. For example, an electronic device user interface may include a page-up key, a page-down key, a line-up key, and a line-down key. A user my press the page-up or page-down key to turn the page display backward or forward. Likewise, the user may press the line-up key or line-down key to move a cursor on the screen or scroll the display screen in the desired direction. A keypad is usually heavy and bulky. After repeated presses, the mechanical components in the keypad may malfunction. Small objects or liquid may fall and moisture may permeate into the keypad to deteriorate its performance or even render it inoperable. In addition, the keypad needs backlight for use in the dark, which would increase the power consumption of the electronic device.

A touchpad user interface generally includes one or more sensing pads. A user touches a specific sensing pad or a specific area on a sensing pad to interact with the electronic device. The sensors, e.g., pressure sensors or capacitance sensors, under the sensing pad sense the user touch and generate control signals corresponding to the user touch to enable the user interface. Compared with a keypad, a touchpad are usually lighter and less bulky. The sensors in a touchpad may be sealed to prevent dust, liquid, or moisture from affecting its performance. In addition, a touchpad may be located in the same area as the display screen, thereby further reducing the bulkiness of the electronic device and eliminating the need for backlight for use in the dark. However, a touchpad can be easily scratched or otherwise damaged after repeated use. Therefore, the durability is a major concern for a user interface with a touchpad.

Accordingly, it would be advantageous to have a user interface that is compact and light weight. It is desirable for the user interface to be energy efficient. It is also desirable for the user interface to be easy to use and durable. It would be of further advantage if the user interface is simple and cost efficient.

### BRIEF DESCRIPTION OF THE DRAWINGS

FIG. 1 is a block diagram illustrating an electronic device having a user interface in accordance with an embodiment of the present invention;

FIG. 2 is schematic diagram illustrating a passive infrared sensing pad in accordance with an embodiment of the present invention; and

FIG. 3 is a flow chart illustrating a passive infrared sensing user interface process in accordance with another embodiment of the present invention.

### DETAILED DESCRIPTION OF VARIOUS EMBODIMENTS

Various embodiments of the present invention are described herein below with reference to the figures, in which elements of similar structures or functions are represented by like reference numerals throughout the figures. It should be noted that the figures are only intended to facilitate the description of the preferred embodiments of the present invention. They are not intended as an exhaustive description of the present invention or as a limitation on the scope of the present invention. Furthermore, the figures are not necessarily drawn to scales.

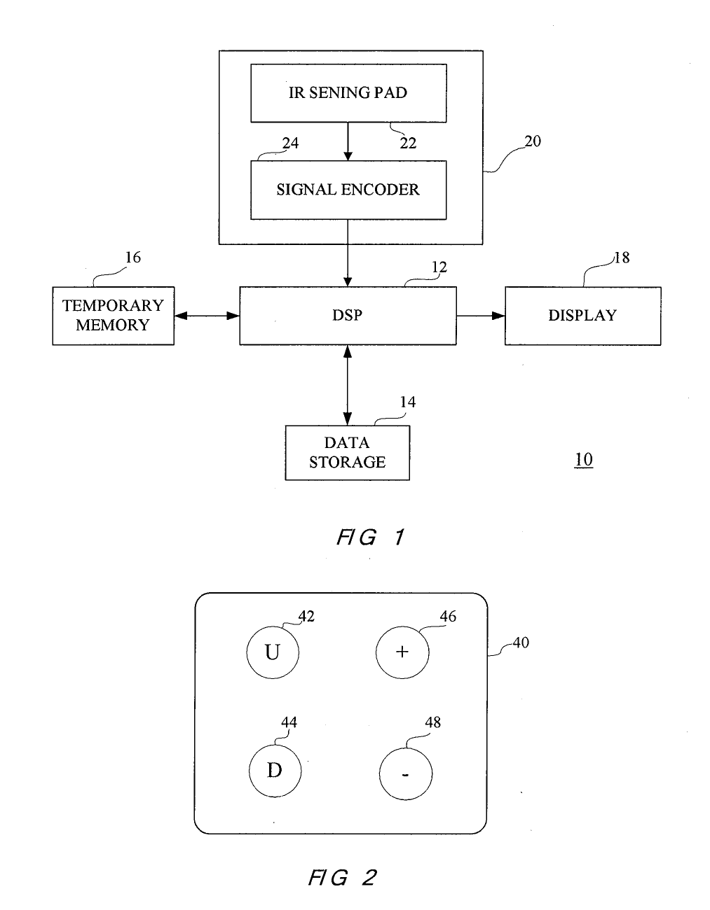

FIG. 1 is a block diagram illustrating an electronic device 10 having a user interface in accordance with an embodiment of the present invention. It should be noted that FIG. 1 shows only those elements in electronic device 10 necessary for the description of the structure and operation of the user interface in accordance with a preferred embodiment of the present invention. By way of example, electronic device 10 may be a digital media device that is often referred to as an electronic book, an e-book, or simply an eBook.

Device 10 includes a digital signal processing unit (DSP) 12, a data storage unit 14, a memory unit 16, and a display unit 18. Data storage unit 14, memory unit 16, and display unit 18 are coupled to digital signal unit 12 via signal transmission buses. In accordance with the present invention, DSP 12 may include a microprocessor (μP), a microcontroller (μC), or a central processing unit (CPU). Data storage unit 14 may include a nonvolatile memory unit such as, for example, a magnetic hard disc, an optical memory disk, read only memory (ROM), flash memory, ferroelectric random access memory (FeRAM), magentoresistive random access memory (MRAM), etc. Memory unit 16 may include a cache memory unit or a volatile memory unit such as, for example, dynamic random access memory (DRAM), static random access memory (SRAM), zero capacitor random access memory (Z-RAM) twin-transistor random access memory (TTRAM), etc. Display unit 18 may include a video display of various kinds, such as, for example, liquid crystal display (LCD), cathode ray tube display (CRT), electroluminescent display (ELD), light emitting diode display (LED), etc. In accordance with the present invention, electronic device 10 may include additional elements not shown in FIG. 1. For example, device 10 may also include an audio system, a radio, a global positioning system (GPS), a data input system, etc.

Electronic device 10 also includes an infrared (IR) sensor 20. In accordance with a preferred embodiment, IR sensor 20 includes passive IR sensing pad 22 and a signal encoder 24. IR sensing pad 22 includes one or more passive IR detectors. The IR detector in sensing pad 22 is connected to signal decoder 24, which is in turn coupled to DSP 12.

In accordance with a preferred embodiment, the sensitivity of a detector in sensing pad 22 is adjusted so that it can detect the presence of a thermal radiation source, e.g., a user's finger tip, directly above and at a short distance such as, for example, between 0.5 millimeter (mm) and 5 mm or between 1 mm and 3 mm from the corresponding detector. Preferably, the distance for detection is sufficiently large so that user does not form a habit of pressing or touching IR pad 22 to interact with electronic device 10, e.g., to navigate the display on display unit 18. On the other hand, the distance for detection is preferably so small that the detector would not detect the finger placed over a neighboring detector in IR sensing pad 22. In addition, the detectors are preferably sensitive only to the IR radiation having wavelengths in an arrange between approximately one micrometer (μm) and 10 μm, which correspond to the wavelengths of the maximum radiation of a human body at the body temperature between around 36 degrees Celsius (° C.) and around 38° C. In a specific embodiment, the detector in IR sensing pad 22 has a maximum sensitivity at the wavelength of approximately 6 μm.

In accordance with an embodiment of the present invention, the passive IR detector includes a focusing lens or mirror and two transducers coupled together in parallel or series with polarities opposite to each other. When the background IR radiation, which spreads substantially evenly over a large space, illuminates the detector, the electric signals generated by the two transducers substantially cancel each other and the net electric signal output of the IR detector remains substantially zero. When a user places a portion of his/her body, e.g., a finger tip, over the detector, the thermal radiation of the finger tip, which is a concentrated or localized finite IR radiation source, transmits through the focusing lens or reflected by the focusing mirror, that focuses the IR radiation of the user finger tip. The focused IR radiation illuminates the two transducers unevenly, thereby generating a nonzero differential electric signal. The focal length of the focusing lens or mirror would determine the distance of detection for the detectors in IR sensing pad 22. In accordance with a specific embodiment of the present invention, the IR detector in IR sensing pad 22 includes a Fresnel lens for focusing the IR radiation onto the transducers.

In operation, DSP 12 processes user commands and data inputs and generates operation codes to data storage unit 14, memory unit 16, and display unit 18. For example, when the user wants to read a chapter in a book stored in eBook 10, the user may uses a keyboard or keypad (not shown in FIG. 1) to input the title of the book and the chapter number into eBook 10. In response to the user input, DSP 12 searches data storage unit 14 for the corresponding book and chapter. After finding the book and chapter matching the user input, DSP 12 stores at last a portion of the chapter in memory unit 16. In response to user instructions, digital processing unit 12 selects sections of data in memory unit 16 and displays the sections of data on display unit 18.

The chapter of the book may be displayed on display unit 18 page by page. In accordance with a preferred embodiment of the present invention, the user may use IR sensing pad 22 to turn the pages forward or backward. In accordance with another preferred embodiment of the present invention, the user may use IR sensing pad 22 to scroll the page down or up. In accordance with yet another preferred embodiment of the present invention, the user may use IR sensing pad 22 to scroll the page to the right or to the left. In accordance with the present invention, the user puts a portion of his/her body, e.g., a finger, or an IR radiation source, e.g., a small light-emitting diode (LED) in the IR band, over IR sensing pad 22, the IR detectors in pad 22 detect the thermal radiation of the finger and generate signals indicating the positions of the finger. Signal encoder 24 converts the signals indicating the user finger positions into digital signals, e.g., digital data packets, and transfer the digital signals to DSP 12.

DSP 12 receives and processes the digital signals from data encoder 24 in IR sensor 20 and generates commands to turn or scroll the pages displayed on display unit 18 according to the digital data packets from data encoder 24. In accordance with an embodiment of the present invention, DSP 12 may generate commands to turn the pages forward or backward. In accordance with another embodiment, DSP 12 may generate commands to scroll the page display down or up line by line. In accordance with yet another embodiment, DSP 12 may generate commands to move the page display to right or left. In other embodiments of the present invention, DSP 12 may generate commands to move a cursor on display unit 18 up, down, left, or right, or move the cursor to the beginning or to the end of the document on display.

By way of example, IR sensing pad 22 includes a single passive IR detector (not shown in FIG. 1) in accordance with an embodiment of the present invention. In such embodiment, DSP 12 includes an algorithm that enables the user to interface with device 10 by placing a portion of his/her body, e.g., a finger tip, over IR sensing pad 22. In accordance with the present invention, the algorithm may be implemented in DSP 12 through software, firmware, or hardware. For example, in response to the user placing his finger tip over IR sensing pad 22 momentarily, e.g., for a time interval of 0.5 second or less, DSP 12 generates a command to turn the page forward by one page or display the next picture on display unit 18. If electronic device 10 is playing an audio or video program, e.g., a collection of songs, DSP 12 may generate a command to pause or suspend the playback or skip to the next track in response to the user finger tip over IR sensing pad 22 momentarily. Also, by way of example, DSP 12 may generate a command to continuously turn the pages forward on display unit 18 or fast forward the playback of the audio or video program in response to the user finger tip over IR sensing pad 22 for an extended time interval, e.g., longer than 0.5 second. In accordance with a preferred embodiment, DSP 12 includes a looping algorithm that displays the first page of the document in response to the user finger tip over IR sensing pad 22 when display unit 18 is displaying the last page. Likewise, the looping algorithm skip to the first track of the audio or video program in response to the user finger tip on IR sensing pad 22 when device 10 is playing the last track of the audio or video program.

It should be understood that DSP 12 is not limited to generating the commands described herein above. By implementing different algorithms, DSP 12 is capable of generating commands for different operations. It should also be understood that IR sensing pad 22 is not limited to having a single passive IR detector as described herein above. In accordance with the present invention, IR sensing pad 12 may include multiple passive IR detectors arranged in various patterns for easy operation of electronic device 10. Generally speaking, the more IR detectors IR sensing pad 22 includes, the more varieties of user interface operations can be implemented in electronic device 10. For operation efficiency, the areas over the detectors in IR sensing pad 22 may be labeled with words, letters, symbols, or graphics so that a user can easily understand the functions associated therewith.

In accordance with another embodiment of the present invention, IR sensing pad 22 includes two passive IR detectors (not shown in FIG. 1), which may be referred to as detectors A and B for the sake of description. In such embodiment, DSP 12 includes an algorithm that enables the user to interface with device 10 by placing a portion of his/her body, e.g., a finger tip, over one or both detectors in IR sensing pad 22. In accordance with the present invention, the algorithm may be implemented in DSP 12 through software, firmware, or hardware. For example, in response to the user placing his finger tip over detector A momentarily, e.g., for a time interval of 0.5 second or less, DSP 12 generates a command to turn the page forward by one page or display the next picture on display unit 18. If electronic device 10 is playing an audio or video program, DSP 12 may generate a command skip to the next track in response to the user finger tip over IR detector A momentarily. In response to the user placing his finger tip over detector B momentarily, e.g., for a time interval of 0.5 second or less, DSP 12 generates a command to turn the page backward by one page or display the previous picture on display unit 18. If electronic device 10 is playing an audio or video program, DSP 12 may generate a command skip to the previous track in response to the user finger tip over IR detector B momentarily. Also by way of example, DSP 12 may generate a command to continuously turn the pages forward on display unit 18 or fast forward the playback of the audio or video program in response to the user finger tip over detector A for an extended time interval, e.g., longer than 0.5 second. Likewise, DSP 12 may generate a command to continuously turn the pages backward on display unit 18 or fast backward the playback of the audio or video program in response to the user finger tip over detector B for an extended time interval, e.g., longer than 0.5 second. In a preferred embodiment, the algorithms implemented in DSP 12 is capable of looping the page display or audio or video playback in ways similar to those described herein above.

In accordance with a preferred embodiment, DSP 12 also includes algorithms for performing operations in response to the user finger moving between detectors A and B in IR sensing pad 22. For example, DSP 12 may generate a command to scroll the display forward or backward in response to the user finger moving from detector A to detector B or from detector B to detector A, respectively, within a predetermined or specified time interval, e.g., one second. DSP 12 may further include algorithms for performing operations in response to the user finger over more than one detector in IR sensing pad 22 simultaneously. For example, DSP 12 may generate a command of zooming-in the display on display unit 18 in response to the user finger or fingers over both detectors A and B in IR sensing pad 22 simultaneously and momentarily, e.g., for a time interval no longer than 0.5 second. In response to the user fingers over both detectors A and B in IR sensing pad 22 simultaneously over an extended time interval, e.g., longer than 0.5 second, DSP 12 may generate a command to perform a zoom-out operation on display unit 18.

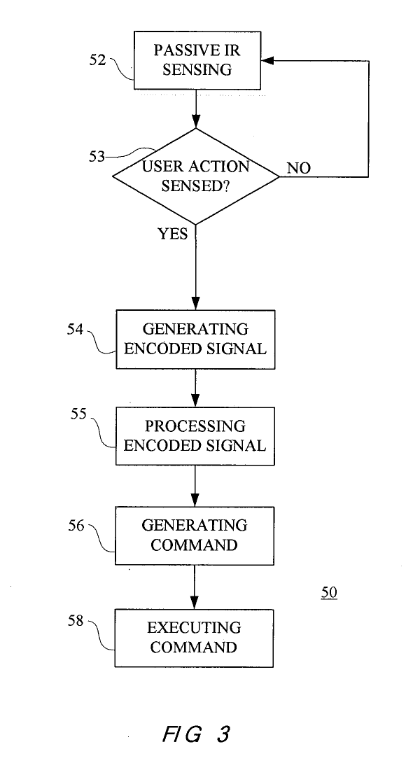

FIG. 2 is schematic diagram illustrating a top view of an IR sensing pad 40 in accordance with an embodiment of the present invention. By way of example, IR sensing pad 40 performs the functions of IR sensing pad 22 in device 10 shown in FIG. 1 and includes passive IR detectors 42, 44, 46, and 48 positioned at four corners of a square and coupled to digital signal encoder 24. By way of example, the distance between detectors 42 and 44 is between approximately 10 mm and approximately 20 mm for easy user interface with electronic device 10. In accordance with a preferred embodiment of the present invention, IR sensing pad 40 includes a film (not shown in FIG. 2) covering IR detectors 42, 44, 46, and 48 to protect them from hazardous elements such as dust and moisture. In accordance with a preferred embodiment, detectors 42, 44, 46, and 48 have similar performance features and characters as the passive IR detector in IR sensing pad 22 described herein above with reference to FIG. 1. Detectors 42, 44, 46, and 48 in IR sensing pad 40 may be labeled with words, letters, symbols, or graphics so that a user can easily understand the functions associated therewith. By way of example, FIG. 2 shows detector 42, 44, 46, and 48 being labeled with “U”, “D”, “+”, and “−”, respectively.

In operation, when the user puts a portion of his body, e.g., a finger tip, or an IR radiation source, e.g., an LED, in close proximity with an IR detector, e.g., detector 42 labeled with “U”, the detector detects the presence of the finger and generates an electric impulse. Digital signal encoder 24 (shown in FIG. 1) converts the signal impulse from detector 42 to a digital signal indicating the presence of the user finger over detector 42. DSP 12 (shown in FIG. 1) processes the digital signal from digital signal encoder 24 and generates a command, e.g., turn the page backward by one page on display unit 18, in response to the user finger over IR detector 42 of IR sensing pad 40.

In accordance with a preferred embodiment of the present invention, the user may instruct device 10 to perform different tasks, such as, turning the page backward or forward, moving a cursor on the display in a desired direction, scrolling the display up, down, left, or right, moving to the beginning or the end of the document on display, zooming-in or zooming-out, etc., by putting the finger over different detectors in IR sensing pad 40. In accordance with the present invention, the user may also instruct device 10 to perform certain tasks by moving a finger tip from over one detector to over another detector in IR sensing pad 40, or continuously placing a finger tip over one or more IR detectors. The algorithms implemented in DSP 12 specify what operations to perform in response to various patterns of the positions and movement of the user finger tip over IR sensing pad 40.

Table 1 shows, by way of example, the commands that DSP 12 generates in response to different patterns in which a user places and moves a portion of his body, e.g., a finger, over detectors 42, 44, 46, and 48 in IR sensing pad 40. In accordance with a preferred embodiment of the present invention, placing a finger over a detector momentarily refers to placing the finger over the detector for a time interval of 0.5 second or less, placing a finger over a detector continuously refers to placing the finger over the detector for a time interval longer than 0.5 second, moving a finger from over one detector to over another detector refers to moving the finger in a time interval of one second or less.

Table 1 shows the operations corresponding to various patterns of user finger over IR sensing pad 40 for three applications: document display, picture display, and audio-video program playback. It should be understood that Table 1 is only an exemplary description of what functions and operations can be implemented in device 10 and activated through passive IR sensing user interface. For a specific device, different functions and operations can be implemented for the efficient operation of the device. It should also be understood that detectors 42, 44, 46, and 48 in IR sensing pad 40 are not limited to being arranged in a square and the distances between neighboring detectors in IR sensing pad 40 is not limited to the ranges specified herein above. In accordance with the present invention, detector 42, 44, 46, and 48 can be arranged in any shape, e.g., linear, triangular, rectangular, rhombic, trapezoidal, etc. Preferably, the spatial arrangements and labeling of the detectors in IR sensing pad 40 are intuitive and convenient to use.

In accordance with another embodiment of the present invention, IR sensing pad 40 includes additional passive IR detectors (not shown in FIG. 2) positioned on the four sides of the square formed by detectors 42, 44, 46, and 48. These additional detectors serve to measure the speed of movement of the user finger from one detector, e.g., detector 42, to another detector, e.g., detector 44, along a side of the square. In accordance with yet another embodiment of the present invention, IR sensing pad 40 includes additional passive IR detectors (not shown in FIG. 2) positioned on diagonals of the square formed by detectors 42, 44, 46, and 48. These additional detectors serve to measure the speed of movement of the user finger from one detector, e.g., detector 42, to another detector, e.g., detector 48, along a diagonal of the square. Additional user interface operations may be implemented in electronic device 10 to utilize the additional passive IR detectors on IR sensing pad 40.

TABLE 1
Passive IR Sensing User Interface Function Table

| Finger Positions/Movements | Operations |
|---|---|
| Over “U” momentarily | Turn page backward by one page/Display the previous |
| | picture/Start and pause the audio-video playback. |
| Over “D” momentarily | Turn page forward by one page/Display the next |
| | picture/Turn on and off the playback repeat. |
| Over “+” momentarily | Enlarge/Zoom-in/Skip to the next track. |
| Over “−” momentarily | Reduce/Zoom-out/Skip to the previous track. |
| Over “U” continuously | Continuously turn page backward/Continuously display |
| | the preceding pictures/Stop the audio-video playback. |
| Over “D” continuously | Continuously turn page forward/Continuously display |
| | the subsequent pictures/Turn on the backlight. |
| Over “+” continuously | Continuously enlarge/Continuously zoom-in/Fast forward. |
| Over “−” continuously | Continuously reduce/Continuously zoom-out/Fast backward. |
| Moving from “U” to “D” | Scroll the page forward/Scroll the picture display |
| | downward/Jump to a subsequent point in the same track. |
| Moving from “D” to “U” | Scroll the page backward/Scroll the picture display |
| | upward/Jump to a preceding point in the same track. |
| Moving from “+” to “−” | Move the cursor down/Move the cursor down/Reduce |
| | the audio volume. |
| Moving from “−” to “+” | Move the cursor up/Move the cursor up/Increase the |
| | audio volume. |
| Moving from “U” to “+” | Move the cursor to the left/Move the cursor to the left |
| | t/Increase the video brightness. |
| Moving from “+” to “U” | Move the cursor to the right/Move the cursor to the right/ |
| | Decrease the video brightness. |
| Moving from “U” to “−” | Switch to a reduced display/Rotate the picture display to |
| | the left/Increase the video contrast. |
| Moving from “−” to “U” | Switch to the full display/Rotate the picture display to |
| | the right/Decrease the video contrast. |
| Moving from “D” to “+” | Display the first page/Display the first picture/Increase |
| | the treble level. |
| Moving from ”+” to “D” | Display the last page/Display the last picture/Decrease |
| | the treble level. |
| Moving from “D” to “−” | Move the cursor to beginning of the document/Move the |
| | upper left of the first picture/Increase the bass level. |
| Moving from “−” to “D” | Move the cursor to end of the document/Move the lower |
| | right of the last picture/Decrease the bass level. |

FIG. 3 is a flow chart illustrating a passive IR sensing user interface process 50 in accordance with an embodiment of the present invention. By way of example, user interface process 50 may be implemented in electronic device 10 shown in FIG. 1. However, this is not intended as a limitation on the scope of the present invention. In accordance with the present invention, process 50 can be implemented in other electronic devices having a passive IR sensor for user interface.

Passive IR sensing ser interface process 50 is implemented through one or more algorithms embedded in an electronic device, e.g., device 10 shown in FIG. 1, through software, firmware, or hardware approach. A digital processing unit, e.g., DSP 12 in device 10, executes the algorithm in response to a digital signal generated by an IR sensor, e.g., IR sensor 20 in device 10, when a user seeks to interact with the device using the IR sensor. The digital signal processing unit generates commands to perform the operations as instructed by the user through the IR sensor.

Passive IR sensing user interface process 50 includes a step 52 of passive IR sensing. A passive IR sensor, e.g., IR sensor 20 in device 10 shown in FIG. 1, detects the thermal radiation of a human body, thereby sensing the presence of a portion of the human body, e.g., a user's finger, in proximity with the IR sensor. In accordance with one embodiment of the present invention, passive IR sensing step 52 senses only the position of the user finger. In accordance with another embodiment, passive IR sensing step 52 senses the position and the movement of the user finger. In order to minimize the interference of the background radiation, passive IR sensing step 52 is preferably sensitive to the IR radiation having the wavelengths in a range, e.g., between approximately 1 μm and approximately 10 μm, matching the thermal radiation characteristics of the human body. In accordance with one embodiment of the present invention, passive IR sensing step 52 further includes generating two electric signals having the amplitudes dependent on the strengths of the sensed thermal radiation and the polarities opposite to each other. Therefore, the two electric signals generated in response to a substantially uniform background thermal radiation substantially cancel each other. In accordance with another embodiment, IR sensing step 52 also includes focusing the thermal radiation of the user finger, so that the two generated electric signals having unequal amplitudes and a net nonzero electric signal is generated in response to the user finger over the passive IR sensor. Focusing the IR radiation can be achieved through a focusing mirror or focusing lens, e.g., a Fresnel lens.

In a step 53, passive IR sensing user interface process 50 determines whether there is a user action sensed in step 52. If no user action sensed, which means there is no significant IR radiation from the user sensed in step 52, process 50 returns to step 52 and waits to sense the user action. In response to the user action being sensed, process 50 proceeds to a step 54 of signal encoding.

In step 54, passive IR sensing user interface process 50 encodes the electric signals generated in step 52 in response to the user finger over the passive IR sensor. By way of example, step 54 can be performed by signal encoder 24 in IR sensor 20 of device 10 shown in FIG. 1. In accordance with preferred embodiments of the present invention, the encoded data include such information as the times, positions, or movements of the user finger over the passive IR sensor. The encoded data are preferably packaged into data packets as specified by a data transmission protocol and transmitted to a digital signal processing unit.

In a subsequent step 55, passive IR sensing user interface process 50 processes the encoded data generated in step 54. By way of example, step 55 can be performed by DSP 12 in device 10 shown in FIG. 1. In step 55, a digital signal processing unit executes or runs one or more algorithms to process the encoded data. In accordance with a preferred embodiment of the present invention, the algorithms include executable programs stored in a memory unit, e.g., ROM unit, in the electronic device. In accordance with another preferred embodiment, the algorithms include firmware codes embedded in the electronic device. In accordance with yet another preferred embodiment, the algorithms includes programs implemented in the electronic device through hardware configuration.

After processing the encoded data in step 55, passive IR sensing user interface process 50 proceeds to a step 56 of generating a user interface command. The commands can be those described herein above with reference to FIGS. 1 and 2. In accordance with the present invention, step 56 can also generate commands other than those described supra by implementing different algorithms in the electronic device. Preferably, step 56 generates the commands for the easy and efficient operation of the electronic device.

In a step 58, user interface process 50 executes the command generated in step 56. By executing the command generated in response to the user interacting with the passive IR sensor, process 50 functions as the user desired and completes the interface process.

After finishing step 58 of executing the user interface command, passive IR sensing user interface process 50 resets itself and is ready for performing step 52 of passive IR sensing for the next interface action by the user. In accordance with an embodiment, process 50 is in a state of performing step 52 of sensing user action upon the electronic device being turned on. In accordance with an alternative embodiment, process 50 is in a state of performing passive IR sensing step 52 even when the electronic device is in a sleep mode or off. In such embodiment, sensing step 52 can serves to wake up or turn on the electronic device in response to the user placing his finger over a designated area of the IR sensor.

It should be understood that a passive IR sensing user interface process is not limited to being process 50 as described herein above. A passive sensing user interface process in accordance with the present invention is preferably application specific to increase the operation efficiency. It may include more or fewer steps than process 50 described supra. For example, a passive IR sensing user interface process in accordance with the present invention may proceed from step 52 of IR sensing to step 54 of encoding data without going through step 53 of determining whether there is a user action sensed. In such embodiment, step 54 may generate a unique data pattern, e.g., a null data, indicating no user action being sensed. In response to the null data, step 55 of processing the encoded data is inactive. In other words, step 55 of processing the encoded data is performed only on the data indicating there is a sensed user action.

By now it should be appreciated that a passive infrared user interface and a device capable of using the interface have been provided. In accordance with the present invention, a user interface includes a passive infrared sensor for detecting the user interface action. After the user interface action being detected, a digital data is generated indicating the user actions. A digital signal processing unit processes the digital data and generates a command as instructed by the user through user interface action.

Passive infrared sensors are energy efficient. They are also light in weight and compact in size. Furthermore, they can be installed in the same area as the display unit, thereby further easing its use and making the device more compact and more energy efficient. In accordance with the present invention, the infrared sensors can be packaged in an airtight package, thereby protecting them from dust, moisture, and other hazardous elements. In addition, a user does not need to press or even touch an infrared sensor to interface with an electronic device, thereby substantially eliminating any scratching or other damages to the infrared sensors. Furthermore, interacting with an electronic device through infrared sensing in according with the present invention does not involve any mechanical component in motion. Therefore, an infrared sensing user interface apparatus in accordance with the present invention is reliable and durable. A user does not need any tool, e.g., a stylus for a touchpad, for interacting with the device, further simplifying the user interface process in accordance with the present invention.

While specific embodiments of the present invention have been described herein above, they are not intended as limitations on the scope of the invention. The present invention encompasses those modifications and variations of the described embodiments that are obvious to those skilled in the art. For example, an electronic device with a passive infrared sensing user interface is not limited to being as a digital media as described above. It can be any other kind of devices such as, for example, a mobile telephone, a personal digital assistant, an appliance remote control unit, a home appliance, office equipment, industry equipment, etc. Also by way of example, the user interface operations are not limited to those described above with reference to the drawings. In accordance with the present invention, the user interface may be implanted to generate other operations such as, for example, adjusting the temperature or humidity setting in an air conditioning unit, opening or closing a door in an electronically controlled entrance system, etc. Further by way of example, an electronic device in accordance with present invention is not limited to having a display unit as described above with reference to the drawings. An electronic device in accordance with the present invention can include a component of any kind, e.g., audio, video, mechanical, magnetic, optical, etc. to perform an operation to execute a command in response to a user interface action on a passive infrared sensor of the device.

1. An electronic device (10), comprising:
a passive infrared sensor (20) including a passive infrared detector having a predetermined distance of detection, and configured to generate a digital signal in response to sensing an infrared radiation of a portion of a human body within the distance of detection;
a digital signal processing unit (12) coupled to said passive infrared sensor, and configured to generate a command in response to the digital signal generated by said passive infrared sensor (20); and
a component coupled to said digital signal processing unit (12), and configured to execute the command generated by said digital signal processing unit (12).

2. The electronic device (10) of claim 1, wherein said passive infrared sensor (20) has the distance of detection in a range between approximately 0.5 millimeter and approximately 5 millimeters.

3. The electronic device (10) of claim 1, wherein said passive infrared sensor (20) is sensitive to infrared radiation having a wavelength in a range between approximately one micrometer and approximately ten micrometers.

4. The electronic device (10) of claim 1, said passive infrared sensor (20) including:
an infrared sensing pad (22) configured to generate an electrical signal impulse in response to sensing an infrared radiation of a portion of a human body within the distance of detection; and
a signal encoder (24) coupled to said passive infrared sensing pad (22) and configured to encoding the electrical signal impulse into the digital signal.

5. The electronic device (10) of claim 4, wherein said infrared sensing pad (22) includes a passive infrared detector having a first transducer and a second transducer coupled together with polarities opposite to each other.

6. The electronic device (10) of claim 5, wherein said digital signal processing unit (12) is configured to generate a first command in response to said passive infrared detector detecting a portion of a human body with the distance of detection momentarily and a second command in response to said passive infrared detector detecting a portion of a human body with the distance of detection continuously.

7. The electronic device (10) of claim 4, said infrared sensing pad (22) including a second passive infrared detector disposed at a distance from said passive infrared detector, wherein said digital signal processing unit (12) is configured to generate:
a first command in response to said passive infrared detector detecting a portion of a human body within the distance of detection momentarily;
a second command in response to said passive infrared detector detecting a portion of a human body within the distance of detection continuously;
a third command in response to said second passive infrared detector detecting a portion of a human body within the distance of detection momentarily;
a fourth command in response to said second passive infrared detector detecting a portion of a human body within the distance of detection continuously;
a fifth command in response to said passive infrared detector and said second passive infrared detector detecting a portion of a human body moving from over said passive infrared detector to said second passive infrared detector; and
a sixth command in response to said passive infrared detector and said second passive infrared detector detecting a portion of a human body moving from over said second passive infrared detector to said passive infrared detector.

8. The electronic device (10) of claim 1, said passive infrared sensor (20) including an infrared sensing pad (22) comprising a plurality of passive infrared detectors coupled to said signal encoder (24), each of said plurality of passive infrared detectors being configured to generate an electrical signal impulse in response to sensing an infrared radiation of a portion of a human body within the distance of detection, wherein said digital signal processing unit (12) is configured to generate a user interface command in response to said plurality of passive infrared detectors detecting a specific pattern user finger positions and movement over said plurality of passive infrared detectors.

9. The electronic device (10) of claim 8, wherein said plurality of passive infrared detectors include four infrared detectors (42, 44, 46, 48).

10. The electronic device (10) of claim 9, wherein said four infrared detectors (42, 44, 46, 48) are arranged in a square.

11. A method for user interface, comprising:
sensing an infrared radiation source in proximity with a passive infrared detector;
generating a digital signal in response to sensing the infrared radiation source in proximity with the passive infrared detector;
generating a command by processing the digital signal; and
executing the command.

12. The method as claimed in claim 11, wherein generating a digital signal includes:
generating an electric signal pulse in response to sensing an infrared radiation source in proximity with the passive infrared detector; and
encoding the electric signal pulse into the digital signal.

13. The method as claimed in claim 11, wherein generating a command by processing the digital signal includes processing the digital signal using an embedded algorithm.

14. The method as claimed in claim 11, wherein sensing an infrared radiation source in proximity with a passive infrared detector includes sensing positions of the infrared radiation source with respect to a plurality of passive infrared detectors.

15. The method as claimed in claim 14, wherein sensing an infrared radiation source in proximity with a passive infrared detector includes sensing a movement of the infrared radiation source with respect to the plurality of passive infrared detectors.

16. A user interface process, comprising the steps of:
sensing an infrared radiation of a portion of a human body within a predetermined distance from a passive infrared detector;
generating a digital signal in response to sensing the infrared radiation of a portion of a human body within the predetermined distance from the passive infrared detector;
generating a command in response to the digital signal; and
executing the command.

17. The user interface process as claimed in claim 16, wherein the step of sensing an infrared radiation of a portion of a human body includes the steps of:
forming a plurality of passive infrared detectors arranged in a spatial pattern; and
detecting the infrared radiation of a portion of a human body over one of the plurality of passive infrared detectors at a time.

18. The user interface process as claimed in claim 17, wherein the step of sensing an infrared radiation of a portion of a human body further includes the step of detecting a movement of the infrared radiation of a portion of a human body over the plurality of the passive infrared detectors.

19. The user interface process as claimed in claim 16, wherein the step of generating a command includes the steps of:
processing the digital signal through an predetermined algorithm to identify a user interface operation; and
generating the command corresponding to the user interface operation.

20. The user interface process as claimed in claim 16, wherein the step sensing an infrared radiation of a portion of a human body includes the steps of:
focusing an infrared radiation of a localized radiation source in response to the radiation source being in proximity to the passive infrared detector; and
generating a nonzero differential signal in response to focused infrared radiation.
